(19) United States
(12) Patent Application Publication
(10) Pub. No.: US 2005/0177291 A1
(43) Pub. Date: Aug. 11, 2005

(54) Work machine with steering control

(75) Inventors: Igor Strashny, Grenoble (FR); Randall Dean Pruitt, Sassenage (FR); Gilles Eyraud, Aix-Le-Bains (FR)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Caterpillar Inc.

(21) Appl. No.: 11/048,854

(22) Filed: Feb. 3, 2005

Related U.S. Application Data
(60) Provisional application No. 60/541,943, filed on Feb. 6, 2004.

(51) Int. Cl. G06F 7/00

(52) U.S. Cl. 701/50

(57) ABSTRACT

A work machine with steering control has a first traction device and a first ratio control device operatively connected to the first traction device. The work machine also has a second traction device and a second ratio control device operatively connected to the second traction device. The work machine further has a power source configured to drive the first and second ratio control devices. The work machine has a sensor configured to generate a signal indicative of work machine maneuvering. The work machine further has a controller in communication with the power source. The controller is operable to control an output of the power source in response to the signal indicative work machine maneuvering.

### RELATED APPLICATIONS

This application is based upon and claims the benefit of priority from U.S. Provisional Application No. 60/541,943 by Igor Strashny et al., filed Feb. 6, 2004, the contents of which are expressly incorporated herein by reference.

### TECHNICAL FIELD

The present invention relates generally to a work machine, and more particularly to a work machine having steering control.

### BACKGROUND

Work machines, including track-type tractors such as the D5 made by Caterpillar Inc., track-type loaders such as the 963 made by Caterpillar Inc., skid-steer loaders, hydraulic tracked excavators, military tanks, and other types of heavy machinery, are used for a variety of tasks. These work machines may include ratio control devices that transmit torque from an engine to one or more traction devices that move the work machine. These ratio control devices may include a hydrostatic transmission, an electric transmission, a mechanical transmission, or any other type of transmission known in the art. The engine may include a diesel engine, a gasoline engine, a natural gas engine, or any other engine configured to operate at a range of output speeds.

The traction devices may be independently manipulated to steer the work machine. For example, during a steering event, a brake may be applied to one or more of the traction devices located on one side of the work machine to allow one or more driven traction devices on the other side of the work machine to turn the work machine. Alternately, one or more driven traction devices located on one side of the work machine may be caused to rotate at a slower speed than or in a direction opposite to one or more driven traction devices located on the opposite side of the work machine to cause the work machine to turn.

Turning a work machine, by any of these methods, may require more torque from the ratio control devices than when the work machine travels in a straight direction. A ratio control device designed for efficiently propelling the work machine in a straight direction may not also have the torque capacity for efficiently turning the work machine at a given speed. Further, a ratio control device designed for efficiently turning the work machine at a given speed may be too large to efficiently propel the work machine in a straight direction.

U.S. Pat. No. 6,654,676 (the '676 patent) issued to Nakagawa et al. on Nov. 25, 2003, describes a steering system for a track-laying vehicle that attempts to account for the different torque requirements of turning and straight-line moving of a work machine. The '676 patent describes a steering system that includes an engine connected to a torque converter, which is connected to a transmission. The transmission is connected to a transverse shaft through a bevel gear that is coupled to right and left planetary gear mechanisms, each of the right and left planetary gear mechanisms being connected to sprockets. The '676 patent also describes a pump and a fixed displacement motor, the motor being coupled to the planetary gear mechanisms.

When a traveling lever in the steering system of the '676 patent is manually operated to cause a pivot turn of the vehicle, a brake is applied to one of the traction devices and the pump and motor are actuated to apply driving force to the planetary gear mechanisms. Simultaneously, the speed of the engine is reduced to prevent over-speed of the pump and motor. After the turn is complete, the driving force from the motor is interrupted from driving the planetary gear mechanisms.

While the steering system of the '676 patent may offer some improved performance during a pivot turn, the steering system of the '676 patent may not provide any efficiencies improvement during other types of turns. In addition, the torque converter, transmission, and planetary gear mechanism arrangement may be complex and costly.

The present invention is directed to overcoming one or more of the problems set forth above.

### SUMMARY OF THE INVENTION

In one aspect, the present disclosure is directed to a work machine with steering control. The work machine includes a first traction device and a first ratio control device operatively connected to the first traction device. The work machine also includes a second traction device and a second ratio control device operatively connected to the second traction device. The work machine further includes a power source configured to drive the first and second ratio control devices. The work machine further includes a sensor configured to generate a signal indicative of work machine maneuvering. The work machine further includes a controller in communication with the power source. The controller is operable to control an output of the power source in response the signal indicative of work machine maneuvering.

In another aspect, the present disclosure is directed to a method of operating a work machine having a power source. The method includes driving a first ratio control device that is operatively connected to a first traction device, and driving a second ratio control device that is operatively connected to a second traction device. The method also includes receiving an input indicative of work machine maneuvering. The method further includes controlling an output of the power source in response to the input indicative of work machine maneuvering.

### BRIEF DESCRIPTION OF THE DRAWINGS

FIG. 1 is a diagrammatic illustration of a work machine according to an exemplary embodiment of the present invention;

FIG. 2 is a diagrammatic illustration of a power system for a work machine according to an exemplary embodiment of the present invention;

FIG. 3 is a flowchart illustrating a method of operating a work machine according to an exemplary embodiment of the present invention; and

FIG. 4 is a graph illustrating a relationship between work machine travel speed, a steering request, and a desired power source speed for a work machine according to an exemplary embodiment of the present invention.

### DETAILED DESCRIPTION

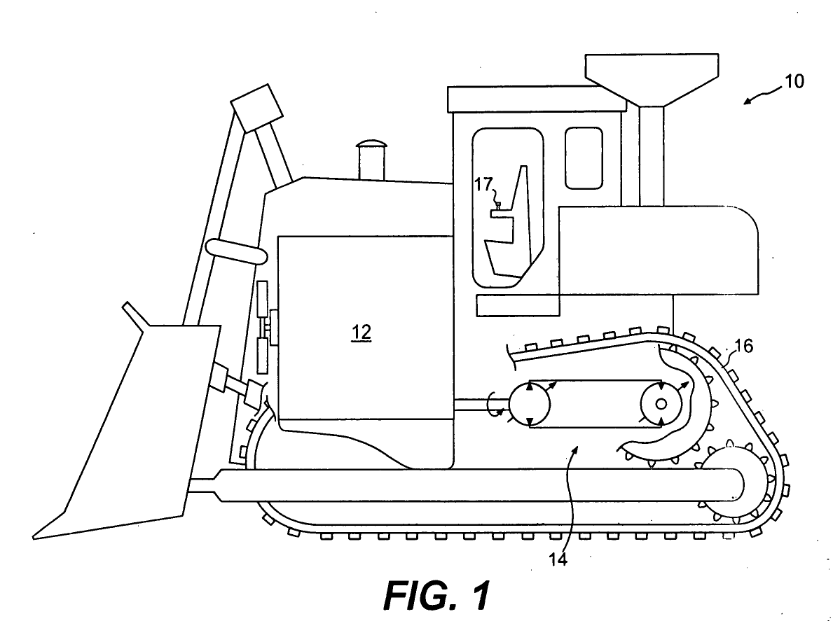

FIG. 1 illustrates an exemplary embodiment of a work machine 10 having a power source 12 and a transmission 14. Transmission 14 may be connected to a plurality of traction devices 16 (only one shown in FIG. 1) controlled by a steering device 17. Power source 12 may be an engine such as, for example, a diesel engine, a gasoline engine, a natural gas engine, or any other engine apparent to one skilled in the art. Power source 12 may also include other sources of power such as a fuel cell, a power storage device, or any other source of power known in the art. Transmission 14 may be a hydrostatic transmission, an electric transmission, a mechanical transmission, a hydro-mechanical transmission or any other means for transmitting power from a power source to a traction device. Traction devices 16 may include tracks, belts, wheels, tires, or any device for moving the work machine. Steering device 17 may include one or more of a steering wheel, a joystick, a lever, a pedal, or any other device for steering the work machine.

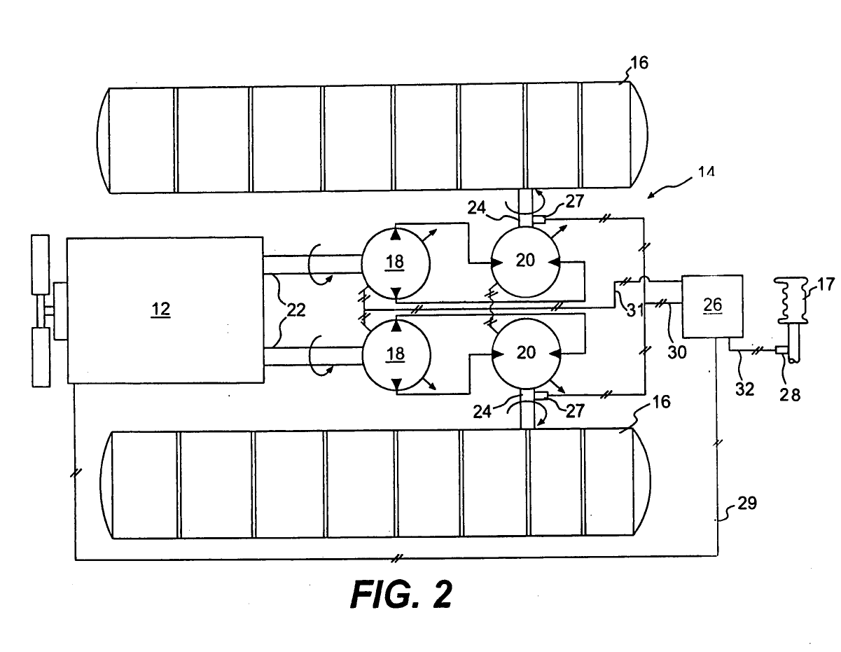

As illustrated in FIG. 2, transmission 14 may be connected to power source 12 and may include two pumps 18 fluidly connected to two motors 20 in a dual-path configuration. Pumps 18 and motors 20 may be variable displacement, variable delivery, fixed displacement, or any other configuration known in the art. Each of pumps 18 may be directly connected to power source 12 via an input shaft 22. Alternately, pumps 18 may be connected to power source 12 via a torque converter, a gear box, or in any other manner known in the art. Transmission 14 may also include an output shaft 24 connecting each motor 20 to one of traction devices 16. Work machine 10 may or may not include a reduction gear arrangement such as, for example, a planetary arrangement disposed between each motor 20 and the associated traction device 16.

Work machine 10 may include a controller 26, one or more transmission output speed sensor 27, and a steering sensor 28. Each speed sensor 27 may be proximally disposed relative to output shaft 24 and configured to generate a signal indicative of the rotational speed of output shaft 24 that corresponds to a work machine travel speed. Alternately, speed sensor 27 may be proximally disposed relative to traction device 16, or may be in any other location for generating a signal that corresponds to work machine travel speed. Sensor 28 may be proximally disposed relative to steering device 17 and configured to generate a signal indicative of a work machine steering request as input by an operator. Controller 26 may be in communication with power source 12, speed sensors 27, variable displacement pumps 18 and motors 20, and sensor 28 via control lines 29, 30, 31, and 32, respectively. Control lines 29, 30, 31, and 32 may be digital, analog, or mixed types of communication lines. Alternately, communication with the various components may be implemented by means of mechanical or hydraulic lines.

Controller 26 may include all the components required to run an application such as, for example, a memory, a secondary storage device, and a central processing unit. Controller 26 may, however, contain additional or different components such as, for example, mechanical or hydro-mechanical devices. Various other known circuits may be associated with controller 26 such as, for example, power supply circuitry, signal-conditioning circuitry, solenoid driver circuitry, and other appropriate circuitry.

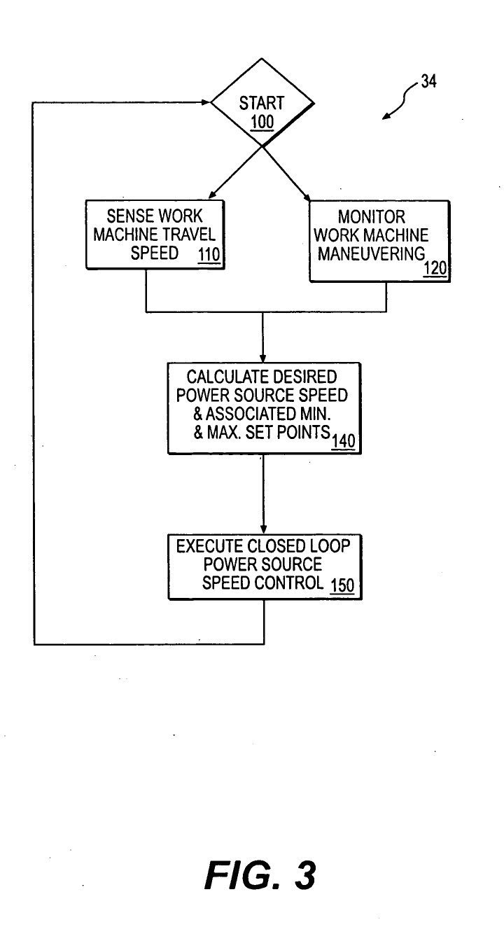

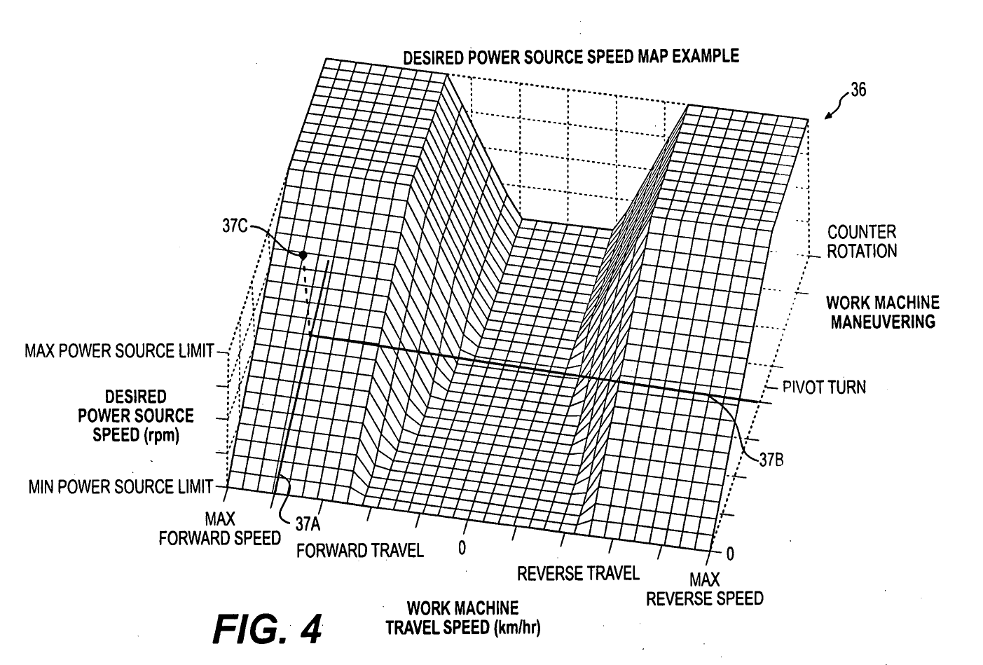

FIG. 3 is a flow chart 34 describing a method of operating work machine 10. FIG. 4 is a graph 36 that illustrates an exemplary power source map exercised by controller 26 for correlating a work machine travel speed, work machine maneuvering, and a desired power source speed. These figures will be discussed in the following section to further illustrate the disclosed system and its operation.

### INDUSTRIAL APPLICABILITY

The disclosed system may be applicable to any work machine that steers by manipulating a speed and/or a torque applied to one or more traction devices. Examples may include a track-type tractor, a track-type loader, a skid-steer loader, a hydraulic-tracked excavator, a military tank, or any other work machine known in the art that utilizes independent traction control for steering.

As described above, steering of a typical work machine may require large amounts of torque from the ratio control devices. Specifically, the torque from the pump 18 and motor 20 that propels an outside (relative to the curvature of the turn) traction device 16 may be significantly greater during a turning operation than when the work machine travels in a straight direction. The disclosed work machine 10 may account for these differences by varying power source speed and/or the displacement of pumps 18 and motors 20 during a steering event. For example, proportionately increasing power source speed, and decreasing the output ratio of the pump 18 and motor 20 associated with the outside traction device 16 increases the torque capacity of transmission 14 without changing the resulting speed of the outside traction device 16. Independently changing an output ratio of transmission 14 may or may not affect the output speed of power source 12. This increased torque capacity of motor 20 associated with the outside traction device 16 may facilitate full or partial utilization of a regenerative braking power that the pump 18 and motor 20 associated with an inside traction device 16 absorb during execution of the requested turning operation. Therefore, a smaller (lower corner power), lower cost transmission 14 that efficiently propels the work machine in a straight direction can also provide the torque for performing efficient turning operations. Such smaller transmissions, in addition to being a lower cost, may produce less heat and require less cooling capacity than their larger (higher corner power) counterparts.

The steering control strategy of work machine 10 will now be explained in detail. As outlined in flow chart 34 of FIG. 3, a method of operating work machine 10 during a turning event begins at step 100. At step 110, controller 26 senses the work machine travel speed via speed sensor 27. At step 120, which may or may not occur simultaneously with step 110, controller 26 monitors work machine maneuvering.

Work machine maneuvering may be monitored in several ways. Work machine maneuvering may be monitored by comparing an indicated travel speed from sensor 27 located on one side of work machine 10 with another sensor 27 located on an opposite side of work machine 10. The difference in travel speeds between opposite sides of work machine 10 may be indicative of the severity of a turn radius initiated during maneuvering of work machine 10. The difference in travel speeds may also be determined by monitoring command speed signals sent to transmission 14. Work machine maneuvering may also be monitored by sensing operator input to steering device 17. A work machine operator may manipulate steering device 17 to indicate a requested change in work machine direction. In response to the operator input to steering device 17 (i.e., a steering request), sensor 28 may send a signal via communication line 32 to controller 26, indicative of the steering.

At step 140, controller 26 may determine a desired power source speed and associated minimum and maximum power source speed set points required to efficiently maneuver the work machine. Controller 26 may compare the sensed work machine travel speed and the value of the work machine maneuvering signal generated in step 120 with a map stored within a memory of work machine 10 to determine a desired power source speed. Alternately, a desired work machine travel speed as input by an operator and the value of the work maneuvering signal may be compared with the map to determine the desired power source speed. The map may be in the form of a look-up table, one or more equations, or another form for storing information.

An example of such a map is illustrated in graph 36 of FIG. 4. Work machine travel speed is plotted along one axis of graph 36. The travel speed axis is split between a forward and reverse direction at a center point of zero kilometers per hour, and extends to the left and right in increasing speeds of opposite travel directions. Work machine maneuvering is plotted along another axis of graph 36, with the turn radius of the work machine increasing from back to front of graph 36. Using the sensed work machine travel speed and the value of the work machine maneuvering signal, a desired power source speed may be determined based on a projection onto a contoured surface of graph 36. The desired power source speed is one that may efficiently maneuver the work machine.

For example, a forward travel speed may be sensed during step 110 and represented as a line 37a on graph 36. The turn radius value of the work machine maneuvering signal sensed in step 120 may be represented as a line 37b on graph 36. Extending a line in the desired power source speed axis direction from the intersection of lines 37a and 37b to the contoured surface of graph 36 determines the desired power source speed 37c, as shown in FIG. 4. For certain travel speed values, a decreasing turning radius will also result in an increasing desired power source speed.

After determining a desired power source speed, minimum and maximum power source speed set points may be determined as offsets from the desired power source speed. For example, offsets 6, and 62 may be added and/or subtracted from the desired power source speed 37c, determined in the above example, to determine maximum and minimum power source speed set points:
Set Point_{Max}=37c+δ₁
Set Point_{Min}=37c−δ₂

It is contemplated that the offset used to determine the minimum power source speed set point may or may not be the same as the offset used to determine the maximum power source speed set point. It is also contemplated that the minimum and maximum power source speed set points may be determined as other functions of the desired power source speed. One of the minimum and maximum power source speed set points may also be determined as a function of the other. In addition, the power source speed set points may be determined directly, in a manner similar to that described above for determining the power source speed, without determining the desired power source speed. The desired power source speed and/or set points may also be determined as functions of parameters other than machine operating and maneuvering parameters.

After the desired power source speed and associated set points are determined, control continues in step 150 with closed loop speed control. Although a desired power source speed has been determined, the minimum and maximum power source speed set points may actually drive the closed loop speed control. The minimum and maximum set points essentially create a zone of acceptable tolerance around the desired power source speed, and the closed loop speed control may change operating parameters of the power source and/or transmission 14 until the power source speed is within the tolerance zone. For example, if the current power source speed is below the minimum set point, operating parameters of the power source 12 and/or transmission 14 may be changed to increase the power source speed. If the current power source speed is above the maximum set point, operating parameters of the power source 12 and/or transmission 14 may be changed to decrease the power source speed. Controller 26 continuously monitors power source speed and adjusts the power source operating parameters and/or transmission parameters when the power source speed deviates from the tolerance zone set by the minimum and maximum set points.

It will be apparent to those skilled in the art that various modifications and variations can be made to the disclosed work machine steering control system without departing from the scope of the invention. Other embodiments of the invention will be apparent to those skilled in the art from consideration of the specification and practice of the invention disclosed herein. It is intended that the specification and examples be considered as exemplary only, with a true scope of the invention being indicated by the following claims and their equivalents.

1. A work machine, comprising:
a first traction device;
a first ratio control device operatively connected to the first traction device;
a second traction device;
a second ratio control device operatively connected to the second traction device;
a power source configured to drive the first and second ratio control devices;
a sensor configured to generate a signal indicative of work machine maneuvering; and
a controller in communication with the power source and operable to control an output of the power source in response to the signal indicative of work machine maneuvering.

2. The work machine of claim 1, wherein the controller is in further communication with at least one of the first and second ratio control devices and is further operable to change a speed ratio of the least one of the first and second ratio control devices in response to the signal indicative of work machine maneuvering.

3. The work machine of claim 2, wherein changing a speed ratio of the least one of the first and second ratio control devices changes the output of the power source.

4. The work machine of claim 1, further including a second sensor configured to generate a signal indicative of a work machine operating parameter, wherein the controller is operable to control an output of the power source in further response to the signal indicative of a work machine operating parameter.

5. The work machine of claim 4, wherein the work machine operating parameter is related to a work machine travel speed.

6. The work machine of claim 5, wherein the work machine travel speed is related to at least one of an output speed of at least one of the first ratio control device and the second ratio control device and a desired work machine travel speed input by an operator.

7. The work machine of claim 1, further including a steering device, wherein the signal indicative of work machine maneuvering is related to operator input to the steering device.

8. The work machine of claim 1, wherein the signal indicative of work machine maneuvering is related to at least one of a speed difference and a command speed difference between the first and second traction devices.

9. The work machine of claim 1, wherein each of the first and second ratio control devices includes a pump and a motor.

10. The work machine of claim 9, wherein at least one of the pump and motor has variable displacement.

11. A method of operating a work machine having a power source, comprising:
driving a first ratio control device that is operatively connected to a first traction device;
driving a second ratio control device that is operatively connected to a second traction device;
receiving an input indicative of work machine maneuvering; and
controlling an output of the power source in response to the input indicative of work machine maneuvering.

12. The method of claim 11, further including controlling a speed ratio of at least one of the first and second ratio control devices in response to the signal indicative of work machine maneuvering.

13. The method of claim 12, wherein controlling a speed ratio of at least one of the first and second ratio control devices changes the output of the power source.

14. The method of claim 11, further including receiving an input indicative of a work machine operating parameter, wherein the step of controlling an output of the power source is further in response to the input indicative of a work machine operating parameter.

15. The method of claim 14, wherein the work machine operating parameter is related to a work machine travel speed.

16. The method of claim 15, wherein the work machine travel speed is related to at least one of an output speed of at least one of the first ratio control device and the second ratio control device and a desired work machine travel speed input by an operator.

17. The method of claim 11, wherein the input indicative of work machine maneuvering is responsive to an operator input to a steering device.

18. The method of claim 11, wherein the input indicative of work machine maneuvering is responsive to at least one of a speed difference and a command speed difference between the first and second traction devices.

19. The method of claim 11, wherein each of the first and second ratio control devices includes a pump and a motor.

20. The method of claim 19, wherein at least one of the pump and motor has variable displacement.

21. A work machine, comprising:
a first means for moving the work machine;
a first means for transmitting power to the first means for moving;
a second means for moving the work machine;
a second means for transmitting power to the second means for moving;
a power source configured to drive the first and second means for transmitting power;
a sensor configured to generate a signal indicative of work machine maneuvering; and
a means for controlling an output of the power source in response to the signal indicative of work machine maneuvering.

22. The work machine of claim 21, wherein the means for controlling an output of the power source is also a means for controlling a speed ratio of at least one of the first and second means for transmitting power in response to the signal indicative of work machine maneuvering.

23. The work machine of claim 22, wherein controlling a speed ratio of at least one of the first and second means for transmitting power changes the output of the power source.

24. The work machine of claim 21, further including a second sensor configured to generate a signal indicative of a work machine operating parameter; wherein the means for controlling is operable to control an output of the power source in further response to the signal indicative of a work machine operating parameter.

25. The work machine of claim 24, wherein the work machine operating parameter is related to a work machine travel speed.

26. The work machine of claim 25, wherein the work machine travel speed is related to at least one of an output speed of at least one of the first and second means for transmitting power and a desired work machine travel speed input by an operator.

27. The work machine of claim 21, further including a means for steering the work machine, wherein the signal indicative of work machine maneuvering is responsive to operator input to the means for steering.

28. The work machine of claim 21, wherein the input indicative of work machine maneuvering is responsive to at least one of a speed difference and a command speed difference between the first and second means for moving the work machine.

29. The work machine of claim 21, wherein each of the first and second means for transmitting power includes a pump and a motor, and at least one of the pump and motor has variable displacement.

30. A controller for a work machine having a power source and at least one ratio control device, comprising:
a processor; and
a memory, wherein the memory includes instructions for performing the steps of:
determining a parameter related to a work machine turn radius;
calculating a desired output of the power source in response to the parameter related a work machine turn radius;
calculating a desired output range; and
changing an output of the power source when the output of the power source is outside of the desired output range.

31. The controller of claim 30, wherein the memory further includes instructions for controlling a speed ratio of the at least one ratio control device in response to the signal indicative of work machine maneuvering.

32. The controller of claim 31, wherein controlling a speed ratio of the at least one ratio control device changes the output of the power source.

33. The controller of claim 30, wherein the memory further includes instructions for performing the step of determining a parameter related to a travel speed of the work machine and the output of the power source is calculated in further response to the parameter related to a travel speed of the work machine.

34. The controller of claim 33, wherein the desired output of the power source is determined by referencing the parameter related to travel speed and the parameter related to work machine turn radius with a look-up table stored in the memory.

35. The controller of claim 30, wherein the desired output range includes an upper and lower limit calculated as a function of the parameter related to the work machine turn radius.

36. The controller of claim 30, wherein the desired output range includes at least one of an upper limit and a lower limit calculated as an offset from the desired output of the power source.

37. A method of operating a work machine having a power source and at least one ratio control device, comprising:
determining a parameter related to a turn radius of the work machine;
calculating a desired output of the power source;
determining a desired output range of the power source; and
changing an output of the power source when the output of the power source is outside of the desired output range.

38. The method of claim 37, further including controlling a speed ratio of the at least one ratio control device in response to the signal indicative of work machine maneuvering.

39. The method of claim 38, wherein controlling a speed ratio of the at least one ratio control device changes the output of the power source.

40. The method of claim 37, wherein determining the desired output range includes at least one of adding an offset value to the desired output of the power source to obtain an upper limit of the desired output range and subtracting an offset value from the desired output of the power source to obtain a lower limit of the desired output range.

41. The method of claim 37, further including determining a parameter related to travel speed of the work machine, wherein the desired output of the power source is calculated as a function of the parameter related to a turn radius of the work machine and the parameter related to travel speed of the work machine.

42. The method of claim 41, wherein determining the desired output of the power source includes referencing the parameter related to travel speed and the parameter related to a work machine turn radius with a look-up table stored in a memory of the controller.

43. The method of claim 41, wherein the parameter related to travel speed includes at least one of an output speed of the at least one ratio control device and a desired work machine travel speed input by an operator.
